(19) United States
(12) Patent Application Publication
(10) Pub. No.: US 2003/0159550 A1
(43) Pub. Date: Aug. 28, 2003

(54) Drum tuning key

(75) Inventor: Fumihiro Shigenaga, Hamakita-shi (JP)

Correspondence Address: Koda & Androlia, Suite 3850, 2029 Century Park East, Los Angeles, CA, 90067, US

(73) Assignee: YAMAHA CORPORATION

(21) Appl. No.: 10/370,008

(22) Filed: Feb. 20, 2003

(30) Foreign Application Priority Data
Feb. 22, 2002 (JP) 2002-45902

(51) Int. Cl. B25F 1/00

(52) U.S. Cl. 81/437

(57) ABSTRACT

A tuning key for a drum including a socket wrench element, which has a receiving opening that fits on the head of a tightening bolt used for tuning the drumhead, and a handle, which is attached to the socket wrench element. The handle is made of a hexagonal bar spanner element that has an L shape and is attached to the socket wrench element so that the spanner element is perpendicular to the axis of the socket wrench element. The socket wrench element is used as a turning handle when rotating a tightening bolt with the socket wrench element. The socket wrench element (and a part of the hexagonal bar spanner element) is used as a turning handle when rotating a hexagonal-hole bolt with the hexagonal bar spanner element.

### BACKGROUND OF THE INVENTION

1. Field of the Invention

The present invention relates to a drum tuning key which is suitable for use on, for instance, a bass drum.

2. Prior Art

Drum tuning keys are special tools that rotate tightening bolts for tuning in an adjustment of the tension of a drumhead. The tuning key shown in FIG. 5 is a typical example of such a drum tuning key (disclosed in Japanese Utility Model Application Publication (Kokoku) No. S58-43033).

The tuning key 1 is comprised of a tubular socket wrench 2 and a T-shaped handle 4. The tubular socket wrench 2 has a polygonal (ordinarily hexagonal or square) receiving opening 3 that fits on the head of a tightening bolt.

FIG. 6 shows another tuning key. This tuning key 5 is comprised of a tubular socket wrench 2 which has a hexagonal receiving opening 3 that fits, in shape, on the head of a tightening bolt. An L-shaped handle 6 is attached to the tubular socket wrench 2. In this tuning key 5 that has an L-shaped handle 6, by way of increasing the length of the arm of the handle 6, it becomes possible to rotate the tuning key more quickly and with a smaller operating force than is required in the tuning key 1 shown in FIG. 5 that has the T-shaped handle 4. Accordingly, the tuning key 5 is advantageous in view of superior operability.

However, since these conventional drum tuning keys 1 and 5 are both socket wrenches that are used to adjust the tension of the drumhead, the use of these tuning keys is limited to hexagonal bolts, square bolts or nuts; and they are not used on a bolt that has a hexagonal-hole in its head (thus called a “hexagonal-hole bolt”).

One example of an instrument that uses hexagonal-hole bolt is a drum foot pedal for a bass drum (see, for instance, Japanese Utility Model Application Publication (Kokoku) Nos. S55-45433 and S58-43035 and Japanese Utility Model Application Laid-Open (Kokai) No. H8-314447.

Accordingly, the player of a bass drum must have, in addition to the tuning key 1 or 5, a spanner for the hexagonal-hole bolt in order to assemble, disassemble and adjust the foot pedal. However, two tools result in an increase in the number of tools required, and it is cumbersome to change tools for each assembly, disassembly and adjustment. Tool management and storage control is also bothersome.

### SUMMARY OF THE INVENTION

The present invention is to solve the above-described conventional problem.

The object of the present invention is to provide an all-purpose drum tuning key which is superior in terms of handling characteristics and is convenient for being used on hexagonal bolts, square bolts, nuts, and hexagonal-hole bolts.

The above object is accomplished by a unique structure for a drum tuning key that is comprised of a socket wrench element, which has a receiving opening that fits on a head of a tightening bolt used for tuning drumhead, and a handle, which is attached to the socket wrench element; and in the present invention, the handle is formed by a hexagonal bar spanner element, and this hexagonal bar spanner element is formed in an L shape and attached to the socket wrench element so that the spanner element is oriented perpendicular to the axis of the socket wrench element.

With the structure described above, hexagonal bolts, square bolts, and nuts are rotated by the socket wrench element, using the hexagonal bar spanner element as a handle for rotating the wrench; and hexagonal-hole bolts are rotated by the hexagonal bar spanner element, using the socket wrench element and a portion of the hexagonal bar spanner element as a handle for turning the hexagonal bar spanner element.

### BRIEF DESCRIPTION OF THE DRAWINGS

FIG. 1 is a partially sectional front view of one embodiment of the drum tuning key according to the present invention;

FIG. 2 is an external perspective view of the base drum and drum foot pedal on which the tuning key of the present invention is used;

FIG. 3 is a sectional view showing how the tuning key of the present invention is used on the tightening bolt of a bass drum;

FIG. 4 is a perspective view of another embodiment of the drum tuning key according to the present invention;

FIG. 5 is a perspective view of a conventional tuning key; and

FIG. 6 is a perspective view of another conventional tuning key.

### DETAILED DESCRIPTION OF THE INVENTION

The present invention will be described in detail below in terms of the embodiments illustrated in the accompanying drawings.

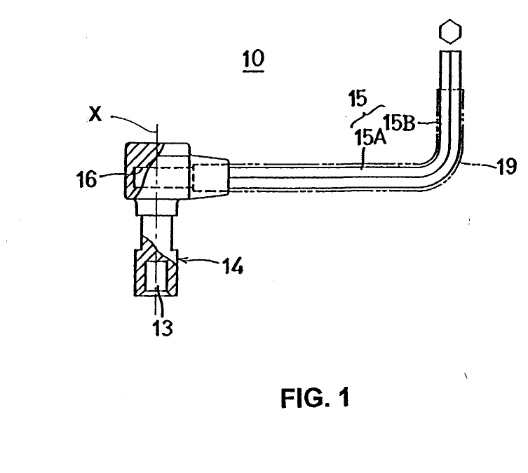

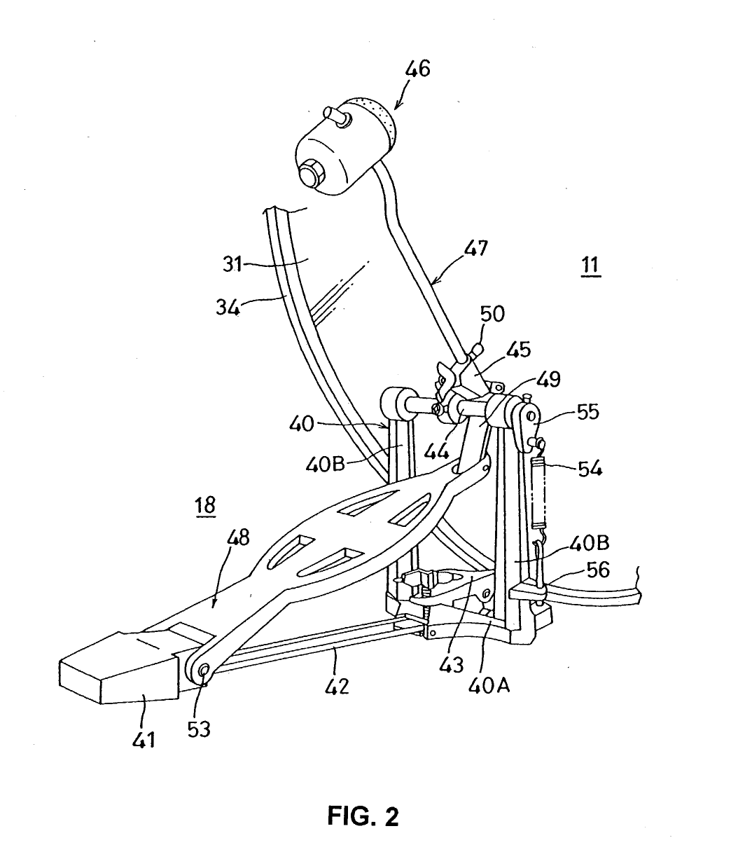

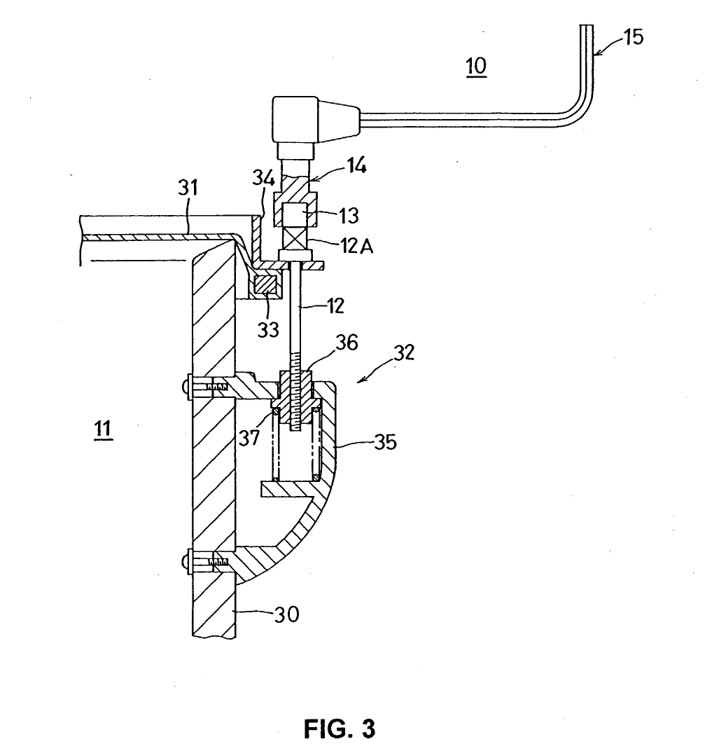

In FIG. 1, the drum tuning key referred to by the reference numeral 10 is comprised of a socket wrench element 14 and a hexagonal bar spanner element 15. The socket wrench element 14 has a receiving opening 13 that fits the head 12A (see FIG. 3) of a tightening bolt 12 (only one shown) of a bass drum 11 (FIG. 2). Thus, the (horizontal) cross-sectional shape of the receiving opening 13 is the same as that of the head 12A of the bolt 12. The hexagonal bar spanner element 15 is attached to the socket wrench element 14 via the handle attachment hole 16.

The socket wrench element 14 is formed in a bar shape that has different external diameter sections. The socket wrench element 14 is typically made of such a material as SCM435 or SCM440 of JIS G 4105 (Chromium-Molybdenum Steel Materials) or SNCM240, etc., of JIS G 4103 (Nickel-Molybdenum Steel Materials). The receiving opening 13 is formed inside of one (the lower or longitudinal) end section of the socket wrench element 14 so as to be a square hole (that is, a square when seen from the end). Another end (the upper or lateral) section of the socket wrench element 14, which is on the opposite side from the receiving opening 13, has a larger diameter than the lower end section. The upper section of the socket wrench element 14 forms an attachment part, and the hexagonal bar spanner element 15 is attached thereto. More specifically, a handle attachment hole 16 which is closed at one end (the left end in FIG. 1) of the socket wrench element 14 is formed in the attachment part so as to extend in the axial direction of the upper or lateral section. The handle attachment hole 16 is thus perpendicular to the axis X of the socket wrench element 14. In other words, the handle attachment hole 16 is perpendicular to the axis of the receiving opening 13 of the socket wrench element 14. The base end portion of the hexagonal bar spanner element 15 is set inside the handle attachment hole 16 and connected thereto by a method such as press-fitting, shrinkage-fitting, etc.

The hexagonal bar spanner element 15 (which is hexagonal in cross-section for its lengthwise entirety) is used to rotate a hexagonal-hole bolt 50 (described later with reference to FIG. 2) that is employed in a drum foot pedal 18. The spanner element 15 is formed in an L shape and is made from the same material as the socket wrench element 14. The spanner element 15 includes an arm portion 15A and a bent portion 15B. The bent portion 15B is bent at the tip end of the arm portion 15A toward the opposite direction from the receiving opening 13 of the socket wrench element 14. The hexagonal bar spanner element 15 can be a commercially marketed spanner element. It is preferable to cover the arm portion 15A and a part of the bent portion 15B with a synthetic resin tube 19 in order to allow easy gripping by hand.

With the tuning key 10 described above, the socket wrench element 14 is used to tighten and loosen square bolts. In this case, the hexagonal bar spanner element 15 is used as a handle for turning the socket wrench element 14 about its axis X. On the other hand, the hexagonal bar spanner element 15 is used to tighten and loosen hexagonal-hole bolts. In this case, the bent portion 15B of the hexagonal bar spanner element 15 is inserted into the hexagonal hole of a hexagonal-hole bolt, and the socket wrench element 14 and arm portion 15A of the hexagonal bar spanner element 15 are used as a handle for turning the bent portion 15B about the axis thereof.

Next, the bass drum 11 and the drum foot pedal 18 on which the tuning key 10 of the present invention is used will be described.

In FIGS. 2 and 3, the bass drum 11 is comprised of a tubular drum main body 30 which is open at both ends, drumheads 31 (only one drumhead is shown) which are respectively stretched over the openings at both ends of the drum main body 30, and head supporting and stretching mechanisms 32 that support and stretch the drumheads 31. The head supporting and stretching mechanism 32 includes a ring-form head frame 33 which holds the outer circumferential edge of the corresponding drumhead 31, a ring-form tightening frame (hoop) 34 that presses against the head frame 33, and a plurality of lugs 35 (only one lug is shown) that are fastened to the outer circumference of the drum main body 30. The tightening bolts 12 (only one bolt is shown) connect lug nuts 36 incorporated in the respective lugs 35 with the tightening frame 34, and springs 37 that drive the lug nuts 36 are provided in the lugs 35.

The head 12A of each of the tightening bolts 12 is a square column of a size that can fit in the receiving opening 13 of the socket wrench element 14 of the tuning key 10. The head 12A is rotated by the tuning key 10 when the tension of the drumhead 31 is to be adjusted. In other words, when the receiving opening 13 of the socket wrench element 14 is fitted on the head 12A of the tightening bolt 12, and the socket wrench element 14 is rotated using the hexagonal bar spanner element 15 as a handle, the tightening bolt 12 is rotated; as a result, the bolt 12 moves up or down. When the tightening bolt 12 is moved up, the pressing force of the tightening frame 34 on the head frame 33 decreases, and thus the tension of the drumhead 31 decreases. When the tightening bolt 12 is moved down, the tightening frame 34 presses the head frame 33 downward, and thus the tension of the drumhead 31 increases. The base drum 11 is a conventionally known item.

In FIG. 2, the drum foot pedal 18 is equipped with a pedal frame 40 that is disposed on a floor surface. The pedal frame 40 is made by die casting from an aluminum alloy, etc., and it includes a plate-form frame main body 40A and two supporting columns 40B that are respectively installed in upright positions as integral parts on the upper surface of the frame main body 40A. A heel 41 is connected to the frame main body 40A via a connecting member 42. A clamp fitting 43 which holds the tightening frame 34 of the bass drum 11 is attached to the upper surface of the frame main body 40A.

A supporting shaft 44 is laterally installed between the upper ends of the supporting columns 40B so as to be rotatable, and a rocker 45 is fastened to the center of the supporting shaft 44. A beater 46 that strikes the drumhead 31 of the bass drum 11 is attached to the rocker 45 via a beater rod 47, and the front end of a foot board 48 is connected to the rocker 45 via a depressing force transmitting member 49.

The beater rod 47 is passed through a rod insertion through-hole formed in the rocker 45 and is pressed and fastened to the wall of the rod insertion through-hole by means of a hexagonal-hole bolt 50. The hexagonal bar spanner element 15 of the tuning key 10 of the present invention is used when the hexagonal-hole bolt 50 is to be tightened or loosened. In other words, when the tip end portion 15B of the hexagonal bar spanner element 15 is inserted into the hexagonal hole of the hexagonal-hole bolt 50 and the tuning key 10 is rotated while the user grips the socket wrench element 14, the hexagonal-hole bolt 50 is tightened or loosened, and the beater rod 47 is attached to or removed from the rocker 45.

The rear end of the foot board 48 is connected to the heel 41 via a connecting pin 53 so that the foot board 48 can pivot upward and downward, and the foot board 48 is caused to return in the upward direction by a return spring 54. The upper end of the return spring 54 is connected to a cam plate 55 installed on one end of the supporting shaft 44, and the lower end of the return spring 54 is anchored on a spring receiving member 56 installed on the lower end of one of the supporting columns 40B.

The foot board 48 is ordinarily held in the initial position state that is shown in FIG. 2. When the foot board 48 is depressed from this state, the depressing force transmitting member 49 is pulled downward, and the supporting shaft 44 is caused to pivot in the clockwise direction in FIG. 2. As a result, the beater rod 47 also pivots together with the supporting shaft 44, and the beater 46 strikes the drumhead 31 of the bass drum 11. When the depressing force is removed from the foot board 48 after striking, the foot board 48 is caused to rise and return to its original position by the spring 54, so that the next depressing operation can be made. The drum pedal 18 is a conventionally known item.

In the shown embodiment, the receiving opening 13 of the socket wrench element 14 is formed as a square hole, and the tuning key (specifically, its wrench 14) is used on square bolts. However, the present invention is not limited to this, and the receiving opening 13 can be formed as a hexagonal hole, and the tuning key is used on hexagonal bolts.

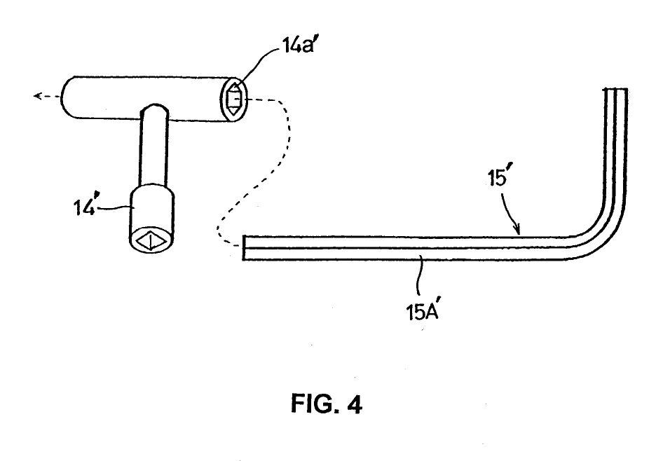

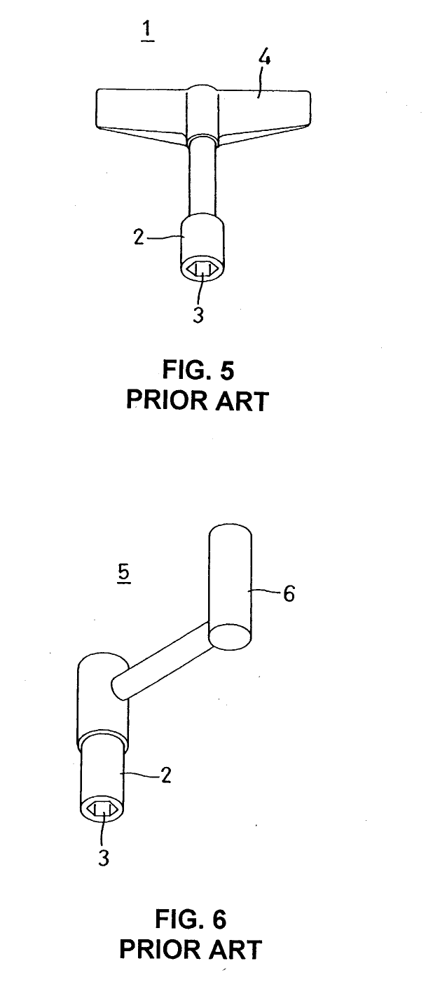

In the shown embodiment, the socket wrench element 14 and the hexagonal bar spanner element 15 are formed into a single integral unit to make the drum tuning key. However, the drum tuning key can be arranged so that the hexagonal bar spanner element is removable from the socket wrench element. In particular, as seen from FIG. 4, the lateral section of a socket wrench element 14′ has an engaging hole 14a′ that is hexagonal in cross section and opened throughout the lateral section. Thus, the arm portion 15A′ of a hexagonal spanner element 15′ is brought into this engaging hole 14a′ of the socket wrench element 14′ with its tip end passed through it, thus forming a single unit with the socket wrench element 14′. The arm portion 15A′ of the hexagonal spanner element 15′ has a cross sectional size that snugly fits in the engaging hole 14a′ of the socket wrench element 14′ with the length of the arm portion 15A′ is longer than the engaging hole 14a′.

As seen from the above, in the structure of FIG. 4, the drum tuning key is comprised of the socket wrench element 14′ and the hexagonal bar spanner element 15′ that are separable. In this structure as well, the socket wrench element 14′ is used to tighten and loosen square bolts with the hexagonal bar spanner element 15′ used as a handle for turning the socket wrench element 14′ about its axis.

As described above, the drum tuning key of the present invention is comprised of a socket wrench element and a hexagonal bar spanner element which is bent in an L-shape; and these elements are formed into a single unit. Accordingly, the drum tuning key is used as a tool that can be commonly used in the assembly, disassembly and adjustment of a bass drums and a drum foot pedal. Thus, the number of tools required can be reduced.

Furthermore, when the socket wrench element is used, the L-shaped hexagonal bar spanner element is used as a turning handle; and when the hexagonal bar spanner element is used, the socket wrench element and a part of the spanner element are used as a turning handle. Accordingly, quick rotation is accomplished using a small operating force in both cases, and a tuning key that is superior in terms of handling is provided by the present invention; and there is almost no chance the tuning key is lost.

1. A drum tuning key comprising a handle and a socket wrench element which has a receiving opening that fits on a head of a tightening bolt used for tuning, wherein
said handle is formed by a hexagonal bar spanner element, and said hexagonal bar spanner element is formed in an L shape and attached to said socket wrench element so that said spanner element is oriented perpendicular to an axis of said socket wrench element.

2. The drum tuning key according to claim 1, wherein said L-shaped hexagonal bar spanner element comprises an arm portion and a bent portion, one end of said arm portion being engaged with said socket wrench element with an axis of said arm portion being perpendicular to said axis of said socket wrench element.
